(19) United States
(12) Patent Application Publication
(10) Pub. No.: US 2006/0282311 A1
(43) Pub. Date: Dec. 14, 2006

(54) Targeted advertisement network that integrates with store-shopping

(76) Inventor: Jianfeng Jiang, San Jose, CA (US)

Correspondence Address: Jianfeng Jiang, 1075 McKay Dr., San Jose, CA, 95131, US

(21) Appl. No.: 11/148,117

(22) Filed: Jun. 9, 2005

(51) Int. Cl. G06Q 30/00

(52) U.S. Cl. 705/14

(57) ABSTRACT

A new targeted Advertisement network that integrates with store-shopping includes at least one on-line provider of advertisements, a network of computers with assigned attributes for displaying the advertisements, a software collecting the assigned attributes of the computers and delivering the advertisements to the computers accordingly, and a desktop program installed in each computer to run the ads and interface with viewers.

### FIELD OF INVENTION

This invention relates to on-line shopping, on-line gaming, on line entertainment, on line advertisements and e-commerce.

### BACKGROUND OF THE INVENTION

Advertisements are one of the most essential parts of business. They exist everywhere, from Radio to TV, from magazines to newspapers. The latest successful ones are the internet web-sites, like Yahoo & Google, etc.

There are also some companies who install many devices like flat panel DVD players in public places, then store all the advertisements in the DVDs and simply play the DVDs.

However, none of the above mentioned advertise methods can deliver ads in real time and targeting specific places and specific people in public places like stores, airports, etc.

Also, none of the above mentioned advertise methods have been able to combine the benefits of both traditional store shopping and on-line shopping, where preferably the shoppers can walk through the isles and see all the Ads. And preferably once the shopper decides to buy a product in the Ad, he can either pay with a credit card instantly or be given a code linked to the displayed product which the shopper can provide to a cashier for scanning.

The proposed network put computers in many public places, in stores along with different isles, in airport waiting areas, alongside the walking steets, etc. The shopping interest of people at above mentioned different places are different. In the stores, a shopper is looking for related goods in that specific isle. While in airport waiting areas, the viewers' shopping interests are more general, but the viewers' profile like income level, age, and shopping interest etc are still different for different places.

In short, the viewers' shopping profiles are different at different locations & different times, these shopping profiles will be decided by the person in charge of that specific displaying computer. With the knowledge of the shopping profiles, the ads can be delivered to these computers according to their viewers' shopping needs. In this way, advertisers can pay less and achieve better results.

The proposed advertisement network can also be integrated with store-shopping using the method proposed in the patent by the same author “On Line Shopping Network that Integrates with Store-Shopping” Ser. No: 10/926413.

Basically, if a shopper is interested in buying a product in the ad, he can either pay through credit card, or he can take a coupon, or print out a ticket for that product and check out with the Cashier.

Furthermore, all the products shown in the ads are listed in the affiliated web-site of the new targeted-advertisement network, the shopper can always check out from the web-site.

Therefore the proposed new advertisement network combines the benefits of both internet and traditional broadcastings, so that the ads can be broadcasted at specific time slots and at specific places targeting specific groups of shoppers, the shoppers can also check out from the computers, or print out a ticket and check out with the cashier like traditional shopping. In this way, e-commerce & traditional shopping are conveniently integrated.

### SUMMARY OF THE INVENTION

In accordance with one aspect of the invention, the new targeted advertisement network that integrates with store-shopping allows the store managers to decide the shopping profiles of the viewers for each computer he is deploying in his store, he then recommends which categories of goods or Ads fit each computer. These profiles can be updated any time by the manager.

In accordance with another aspect of the invention, the network management software for the new targeted advertisement network gathers all the profiles for each computer and delivers the Ads to the computers accordingly.

In accordance with one other aspect of the invention, the advertisers can choose when and where to display their ads to achieve the best results with least amount of spending.

In accordance with yet another aspect of the invention, the new targeted advertisement network can gather the viewing and sales history generated by the ads for each location and an effectiveness rating can be generated for each location and time, which provides feedback to the advertisers.

In accordance with one last aspect of the invention, a bidding platform can be built for the advertisers to bid for the locations and times of displaying their ads. the advertisers can have access to the viewing and sales data for each terminal to help them decide the return-on-investments for each terminal.

### BRIEF DESCRIPTION OF THE DRAWINGS

FIG. 1 is a schematic representation of the new targeted advertisement network in accordance with the invention.

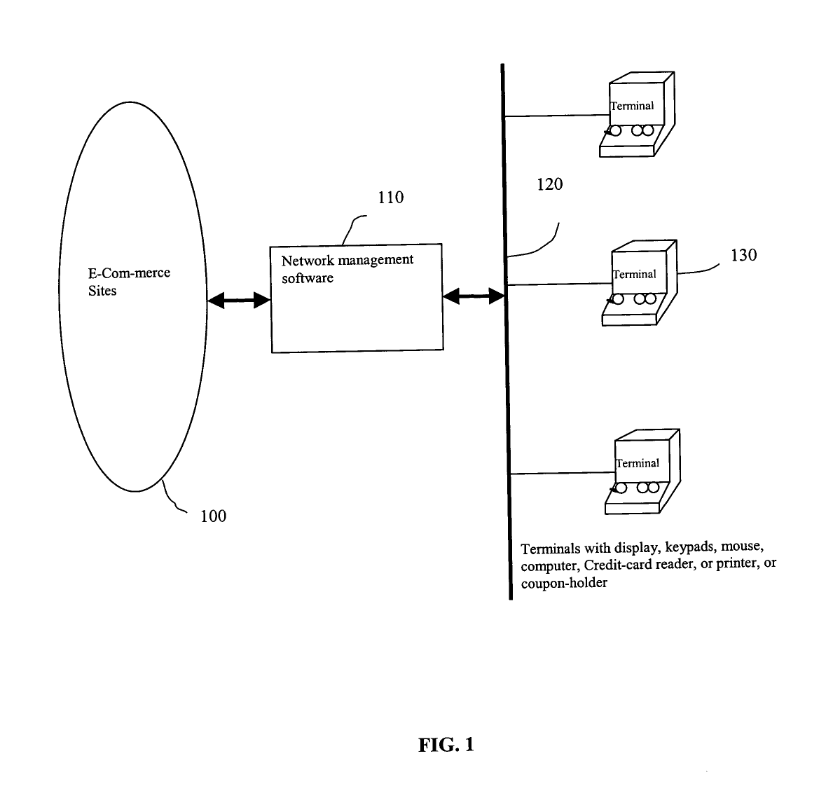

### DETAILED DESCRIPTION OF THE INVENTION

The present invention relates to a new targeted advertisement network that integrates with store_shopping. The following description is presented to enable one of ordinary skill in the art to make and use the invention as provided in the context of a particular application and its requirements. Various modifications to the preferred embodiment will be apparent to those with skill in the art and the general principles defined herein may be applied to other embodiments. Therefore, the present invention is not intended to be limited to the particular embodiments shown and described, but is to be accorded the widest scope consistent with the principles and novel features herein disclosed.

The new targeted advertisement network may include at least one e-commerce site 100. A network of terminals 130 may be coupled to the e-commerce site 100 by means of a distributed network such as the internet 120. Each terminal 130 may include display, keypads, mouse, computers, credit card readers, printers and coupon holders. The e-commerce site 100 has secured log-ins for advertisers and store managers. The store managers are responsible for placing the terminals 130 and determine what kind of ads are best for each terminal 130. The store managers can then log into their accounts at the e-commerce site 100 and input how many terminals 130 they have placed and what categories of ads and what times are best for each terminal 130. With these detailed information of the terminals 130, the advertisers can choose when and where to place their ads, so that they can spend less and achieve better results.

A network management software 110 then makes the displaying schedule for each terminal 130, i.e. What ads to display and in what order to display. The network management software 110 then downloads the corresponding ads to each terminal 130 through internet 120, and save them in the local hard-disk of each terminal 130.

Each terminal 130 has a desktop program that runs the ads and interfaces with the viewer. That is. If the viewer is interested in one ad, he can pause the ad, make the purchase using credit card, or he can ask for a ticket or coupon linked with the ad, and check out at the cashier.

The desktop program also stores the viewer interface and sales history and uploads the data to the network management software 110. The data can be analyzed to establish an effectiveness rating for each terminal 130.

All the advertisements displayed at the public terminals 130 are available at the at least one e-commerce site 100, the buyer can also check out from the at least one e-commerce site 100. The buyers can also provide feedback for each Ad on when and where they saw the Ad. These feeback will also be used for the effectiveness rating system for all the terminals 130.

In places where the same ads are to be displayed on all computers, a local server driving several monitors can be used to save costs. The server interacts with e-commerce sites through the internet, and delivers the ads to all the monitors.

The following claims are therefore made:

1. A new targeted advertisement network comprising:
At least one on-line provider of advertisements;
A network of terminals coupled to the at least one on-line provider of advertisements;
A desktop program running on the terminals; and
A network management software.

2. The new targeted advertisement network of claim 1, wherein the terminals comprise a displaying monitor.

3. The new targeted advertisement network of claim 1, wherein the terminals comprise an input/output device.

4. The new targeted advertisement network of claim 3, wherein the input/output device comprises a touch screen.

5. The new targeted advertisement network of claim 3, wherein the input/output device comprises a mouse.

6. The new targeted advertisement network of claim 3, wherein the input/output device comprises a keyboard.

7. The new targeted advertisement network of claim 1, wherein the terminals are displayed in physical stores and at public places.

8. The new targeted advertisement network of claim 1, wherein the terminals can communicate with the at least one on line provider of advertisements.

9. The new targeted advertisement network of claim 1, wherein the at least one on-line provider of advertisements comprises an e-commerce website accessible over a distributed network.

10. The new targeted advertisement network of claim 1, wherein the desktop program comprises means for displaying the Ads.

11. The new targeted advertisement network of claim 1, wherein the desktop program comprises means of storing the viewing and sales history of the terminal.

12. The new targeted advertisement network of claim 1, wherein the desktop program comprises means of communicating with the website application server.

13. The new targeted advertisement network of claim 1, wherein the network management software comprises means of setting the best advertisement displaying times and categories for each terminal.

14. The new targeted advertisement network of claim 1, wherein the network management software comprises means for advertisers to submit ads and choose when and where to display the ads.

15. The new targeted advertisement network of claim 1, wherein the network management software comprises means of scheduling the Ad content and displaying times for each terminal.

16. The new targeted advertisement network of claim 1, wherein the network management software comprises means of collecting the viewing and sales data for all the terminals, and provides the effectiveness rating for each terminal.

17. The new targeted advertisement network of claim 1, wherein the network management software comprises means for the advertisers to bid for specific locations and time slots to place Ads.

18. The new targeted advertisement network of claim 1, wherein the network of terminals comprises a credit card reader.

19. The new targeted advertisement network of claim 1, wherein the network of terminals comprises an ID code dispenser.

20. The new targeted advertisement network of claim 18, wherein the ID code dispenser comprises a printer.

21. The new targeted advertisement network of claim 18, wherein an ID code comprises a bar code.

22. The new targeted advertisement network of claim 18, wherein an ID code comprises a user-defined code.
